(19) United States
(12) Patent Application Publication
(10) Pub. No.: US 2023/0314573 A1
(43) Pub. Date: Oct. 5, 2023

(54) MASTER DEVICE AND SENSOR SYSTEM

(71) Applicant: Fujitsu Limited, Kawasaki-shi (JP)

(72) Inventors: Katsushi SAKAI, Zama (JP); Shinichi FUJIYOSHI, Fukuoka (JP)

(73) Assignee: Fujitsu Limited, Kawasaki-shi (JP)

(21) Appl. No.: 18/152,923

(22) Filed: Jan. 11, 2023

(30) Foreign Application Priority Data
Mar. 30, 2022 (JP) 2022-056188

(51) Int. Cl. G01S 7/4865; G02B 26/12; G02B 26/08

(52) U.S. Cl. CPC G01S 7/4865; G02B 26/123; G02B 26/0833; G01S 17/93

(57) ABSTRACT

A master device includes: a light emission circuit configured to emit first laser light; an amplitude control circuit configured to control a scanning amplitude of a micro electro mechanical system (MEMS) mirror that scans the first laser light in a raster scan method; a timing data generation circuit configured to generate timing data that indicates a timing when a scanning angle of the MEMS mirror becomes zero, based on an operation of the MEMS mirror; a buffer configured to store the timing data in one frame of the scanning of the MEMS mirror; a light emission control circuit configured to control light emission of the first laser light by the light emission circuit, based on the timing data generated by the timing data generation circuit; and a data output circuit configured to output data to a slave device that operates dependent on an own device.

### CROSS-REFERENCE TO RELATED APPLICATION

This application is based upon and claims the benefit of priority of the prior Japanese Patent Application No. 2022-56188, filed on Mar. 30, 2022, the entire contents of which are incorporated herein by reference.

### FIELD

The present disclosure discussed herein is related to a master device and a sensor system.

### BACKGROUND

Typically, there is an optical scanning device in which a first phase control unit corresponding to a first scanner unit controls a phase of a polygon mirror based on a beam detect (BD) signal output from a first BD sensor and a target phase. Furthermore, a second phase control unit corresponding to a second scanner unit controls a phase of a second polygon mirror based on a BD signal output from a second BD sensor and a target phase set with reference to the target phase.

Japanese Laid-open Patent Publication No. 2021-049691 is disclosed as related art.

### SUMMARY

According to an aspect of the embodiments, a master device includes: a light emission circuit configured to emit first laser light; an amplitude control circuit configured to control a scanning amplitude of a micro electro mechanical system (MEMS) mirror that scans the first laser light emitted by the light emission circuit in a raster scan method; a timing data generation circuit configured to generate timing data that indicates a timing when a scanning angle of the MEMS mirror becomes zero, based on an operation of the MEMS mirror; a buffer configured to store the timing data in one frame of the scanning of the MEMS mirror; a light emission control circuit configured to control light emission of the first laser light by the light emission circuit, based on the timing data generated by the timing data generation circuit; and a data output circuit configured to output data to a slave device that operates dependent on an own device. When the scanning amplitude of the first laser light on the MEMS mirror is changed, the light emission control circuit controls the light emission by using the timing data for one frame held by the buffer instead of the timing data generated by the timing data generation circuit, and the data output circuit outputs the timing data for one frame stored in the buffer to the slave device.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a schematic diagram illustrating an overall configuration of a posture recognition system 400 according to an embodiment;

FIG. 2 is a diagram for explaining raster scan of a master device 100M;

FIG. 3 is a diagram illustrating an example of a relationship between the master device 100M and a ranging target 1;

FIG. 4 is a diagram for explaining internal configurations of a micro controller unit (MCU) 110 and a field programmable gate array (FPGA) 130M of the master device 100M;

FIG. 5 is an explanatory diagram of a Time OF Flight (TOF) method;

FIG. 6 is a diagram for explaining an internal configuration of a slave device 100S;

FIG. 7A is a diagram for explaining generation, storage, and holding of timing data in a timing output unit 140 and transmission of the timing data to the slave device 100S;

FIG. 7B is a diagram for explaining the generation, the storage, and the holding of the timing data in the timing output unit 140 and the transmission of the timing data to the slave device 100S;

FIG. 8 is a diagram illustrating an example of a master device 50M for comparison;

FIG. 9 is a diagram illustrating horizontal sampling regions of the master device 50M and the slave device 100S;

FIG. 10 is a diagram illustrating horizontal sampling regions of the master device 100M and the slave device 100S;

FIG. 11 is a flowchart illustrating an example of processing related to light emission control in the master device 100M and the slave device 100S;

FIG. 12A is a diagram for explaining angle-of-view control;

FIG. 12B is a diagram for explaining the angle-of-view control;

FIG. 12C is a diagram for explaining the angle-of-view control;

FIG. 13A is a diagram illustrating a state of temporal changes in an amplitude change enable signal EN input to the master device 100M and an angle of view of a micro electro mechanical system (MEMS) mirror 12 of the master device 100M;

FIG. 13B is a diagram illustrating a state of temporal changes in an amplitude change enable signal EN input to the master device 50M for comparison and an angle of view of the MEMS mirror 12 of the slave device 100S that operates with timing data acquired from the master device 50M for comparison;

FIG. 13C is a diagram illustrating a state of temporal changes in the amplitude change enable signal EN input to the master device 100M and an angle of view of the MEMS mirror 12 of the slave device 100S that operates with timing data acquired from the master device 100M;

FIG. 14 is a diagram illustrating an application example of the posture recognition system 400; and

FIG. 15 is a diagram illustrating a hardware configuration example of the master device 100M.

### DESCRIPTION OF EMBODIMENTS

By the way, since the first scanner unit and the second scanner unit of the typical optical scanning device do not have a master-slave relationship such as a master device and a slave device that operates dependent on the master device, a control amount of one device does not affect a control amount of another device in the configuration of the optical scanning device.

Therefore, an object is to provide a master device and a sensor system that can supply timing data that stably operates a slave device to the slave device.

Hereinafter, an embodiment to which a master device and a sensor system according to the present disclosure are applied will be described.

### Embodiment

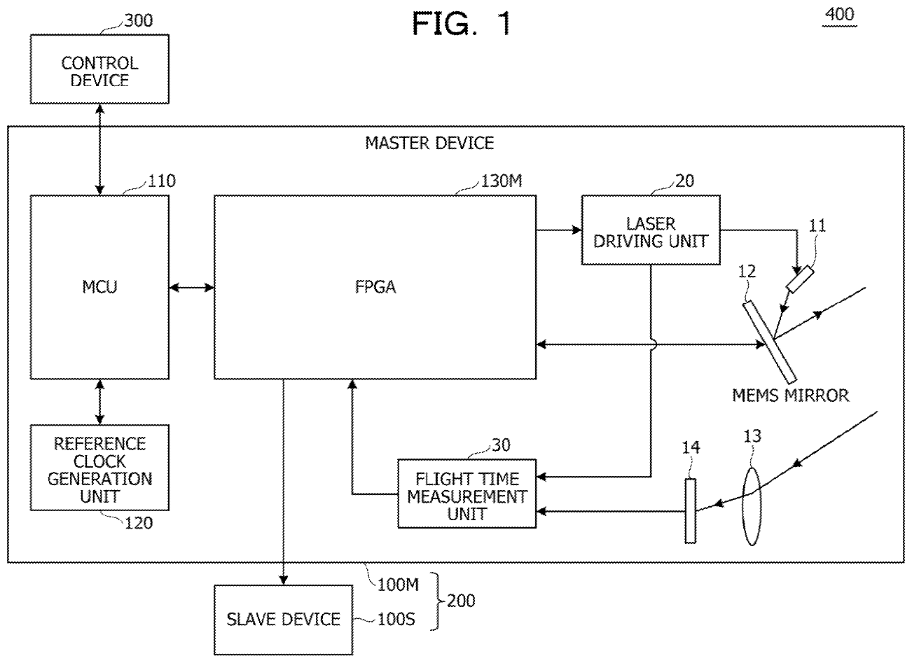

FIG. 1 is a schematic diagram illustrating an overall configuration of a posture recognition system 400 according to an embodiment. As illustrated in FIG. 1, the posture recognition system 400 includes a master device 100M, a slave device 100S, and a control device 300. Although the posture recognition system 400 may include a plurality of the slave devices 100S, here, a form including the single slave device 100S will be described as an example.

The master device 100M and the slave device 100S construct a sensor system 200. Therefore, the posture recognition system 400 includes the sensor system 200 and the control device 300. The master device 100M, the slave device 100S, and the control device 300 are connected via a wired or wireless network so as to perform data communication. Note that, in a case where there is a plurality of the slave devices 100S, the sensor system 200 includes the plurality of slave devices 100S.

The posture recognition system 400 is a system that recognizes a posture of a ranging target, by measuring a distance to each part of the ranging target, by scanning (scan) the ranging target with laser light emitted from the master device 100M and the slave device 100S, using the master device 100M and the slave device 100S as a sensor device (measurement device). The ranging target may be any object, but here, an athlete who performs gymnastics is taken as an example.

The master device 100M and the slave device 100S emit laser light at timings (measurement cycles) different from each other and receive reflected waves reflected by the ranging target, through synchronization control in cooperation with each other. Because if laser light emitted from a device other than the own device is wrongly received, it is not possible to obtain a correct measurement result. Therefore, the master device 100M and the slave device 100S alternately emit and receive laser light so that periods when the own device emits or receives the laser light do not overlap. Note that, in a case where there is the plurality of slave devices 100S, it is sufficient that the emissions or the receptions of the laser light of each of the master device 100M and the plurality of slave devices 100S do not overlap. In this case, the master device 100M and one of the plurality of slave devices 100S may alternately emit and receive the laser light so that periods of laser light emission and reception do not overlap.

Since the master device 100M and the slave device 100S have substantially similar hardware configurations and have few differences, a hardware configuration of the master device 100M is illustrated in FIG. 1. A difference between the master device 100M and the slave device 100S will be described later.

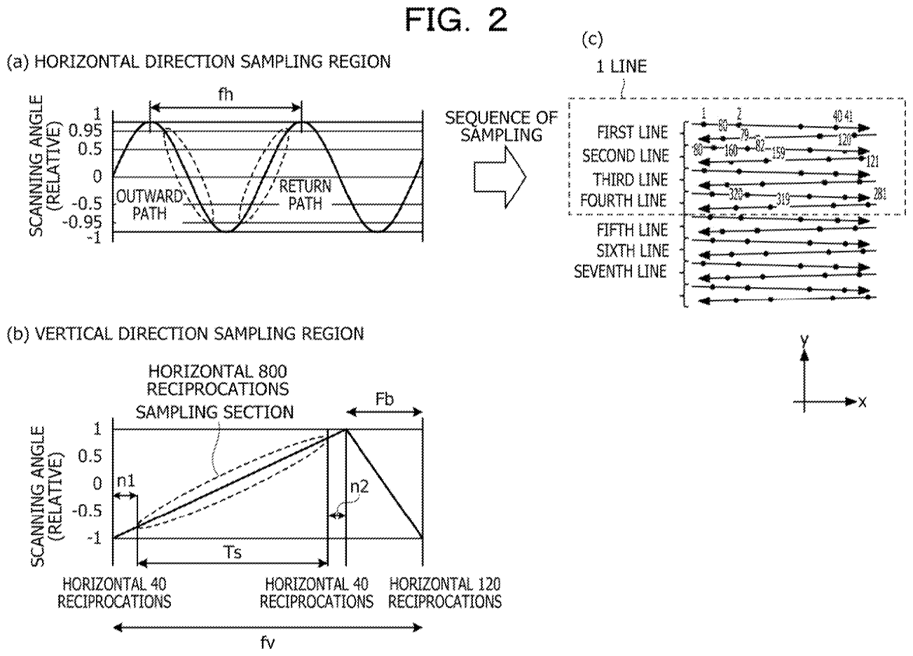

The master device 100M includes a light emission device 11, a micro electro mechanical system (MEMS) mirror 12, a light receiving lens 13, a light receiving element 14, a laser driving unit 20, a flight time measurement unit 30, a micro controller unit (MCU) 110, a reference clock generation unit 120, and a FPGA 130M. In the master device 100M, the light emission device 11 is an example of a first light emission unit, and laser light emitted by the light emission device 11 is an example of first laser light. The MEMS mirror 12 is an example of a first MEMS mirror, and the light receiving element 14 is an example of a first light reception unit. The MCU 110 is an example of a first control device, and the reference clock generation unit 120 is an example of a timing data generation unit. Here, before a specific configuration of the master device 100M is described, raster scan of the master device 100M will be described with reference to FIG. 2.

<Raster Scan of Master Device 100M>

FIG. 2 is a diagram for explaining raster scan of the master device 100M. In FIG. 2, the master device 100M will be described. However, the slave device 100S also performs similar raster scan. In the cooperation between the master device 100M and the slave device 100S, the master device 100M alternately emits the laser light and performs measurement through the synchronization control described above.

FIG. 2(a) illustrates a horizontal direction sampling region (horizontal axis indicates time, and vertical axis indicates scanning angle in horizontal direction of laser light). FIG. 2(b) illustrates a vertical direction sampling region (horizontal axis indicates time (horizontal reciprocating scanning period of 200 reciprocations of MEMS mirror 12), and vertical axis indicates scanning angle in vertical direction of laser light). FIG. 2(c) illustrates a position of sampling data on a reflective surface (x and y axes) of the MEMS mirror 12.

In FIG. 2(a), the vertical axis indicates a relative scanning angle in the horizontal direction. “+1” and “−1” in the vertical axis represent scanning amplitudes of the MEMS mirror 12 in the horizontal direction, and indicate that the scanning amplitude in the horizontal direction is “1”. The relative scanning angle can be values between ±1, and “−1” in the vertical axis indicates the smallest scanning angle in the horizontal direction, and “1” indicates the largest scanning angle in the horizontal direction. Reciprocation of the relative scanning angle in the horizontal direction between “−1” and “1” reciprocates the scanning angle in the horizontal direction once. A horizontal driving signal is a sine wave.

In FIG. 2(b), the vertical axis indicates a relative scanning angle in the vertical direction. “+1” and “−1” in the vertical axis represent scanning amplitudes of the MEMS mirror 12 in the vertical axis, and indicate that the scanning amplitude in the vertical direction is “1”. “−1” in the vertical axis indicates the smallest scanning angle in the vertical direction, and “1” in the vertical axis indicates the largest scanning angle in the vertical direction. Reciprocation of the relative scanning angle in the vertical direction between “−1” and “1” reciprocates the scanning angle in the vertical direction once. Each angle obtained by dividing the relative scanning angle in the vertical direction by 1000 corresponds to each line.

Here, it is assumed that the number of samplings per frame (one frame period) be 64,000 points (raster scan (progressive) of x axis 320*y axis 200), a resonance frequency (unique frequency) fh of the MEMS mirror 12 in the horizontal direction be about 28.3 Hz (one cycle, one frame data), and data sampling be 3.2 MHz. The number of frames is 30 per second.

As illustrated in FIG. 2(a), the MEMS mirror 12 vibrates in the horizontal direction at the resonance frequency fh (for example, about 28.3 kHz) with a driving signal and samples 80 points in one section including a pair of an outward path and a return path at a fixed sampling interval of 320 ns. The MEMS mirror 12 samples 320 points in four reciprocations in the horizontal direction (refer to FIG. 2(c)). The MEMS mirror 12 generates a trigger of sampling start based on a sensor signal of the MEMS mirror 12 for each section. As a result, as illustrated in FIG. 2(c), sampling data of 320 points is acquired in four reciprocations. In one reciprocation, 80 points are sampled so as to fill a gap by shifting the horizontal angle for each reciprocation. In one reciprocation, 40 points are sampled in an outward path from “0.95” to “−0.95”, and 40 points are sampled in a next return path from “−0.95” to “0.95”.

In FIG. 2(b), the MEMS mirror 12 vibrates in the vertical direction at a frequency fv (for example, about 28.3 Hz) with a driving signal. The MEMS mirror 12 increases the scanning angle in a measurement period Ts of an entire period of horizontal reciprocations (200 reciprocations in total) and decreases an operating angle in a period other than the measurement period Ts (corresponding to flyback period Fb). Note that, since an effect of an amplitude is excluded in a predetermined period of each of start and end of the period when the scanning angle increases (horizontal 40 reciprocations), the predetermined periods are assumed as dead bands n1 (horizontal 40 reciprocations) and n2 (horizontal 40 reciprocations) that are not used for measurement. It is assumed that a sampling period of horizontal 800 reciprocations excluding the dead bands n1 and n2 be the measurement period Ts. Note that, the flyback period Fb corresponds to horizontal 120 reciprocations. The dead bands n1 and n2 are non-light-emission periods of the MEMS mirror 12 in the horizontal resonance direction.

In the synchronization control in which the master device 100M and the slave device 100S are in cooperation, laser light emissions are strictly synchronized per frame data, and a light emission timing is controlled so as not to cause mutual interferences. Then, by sampling 64,000 points per frame, three-dimensional point cloud data of the 64,000 points is acquired.

In order to acquire such three-dimensional point cloud data, the master device 100M controls emission of laser light, with reference to a timing when the scanning angle of the MEMS mirror 12 in the horizontal direction becomes zero (hereinafter, referred to as zero timing). Furthermore, the slave device 100S controls emission of laser light with reference to the zero timing supplied from the master device 100M.

Furthermore, in the synchronization control in which the master device 100M and the slave device 100S are in cooperation, for example, there is a case where an angle of view of a case where the MEMS mirror 12 performs scanning in a raster scan method is changed, in accordance with a change in a distance to a ranging target caused by movement of the ranging target. The master device 100M and the slave device 100S change an angle of view in response to an amplitude change command input from the control device 300.

Since the control device 300 (refer to FIG. 1) can detect a position of a ranging target 1 from measurement results of the master device 100M and the slave device 100S, the control device 300 can set an angle of view according to distances between the master device 100M and the slave device 100S, and the ranging target 1. Note that the angle of view is changed in both of the horizontal direction and the vertical direction in order to prevent distortion of an image.

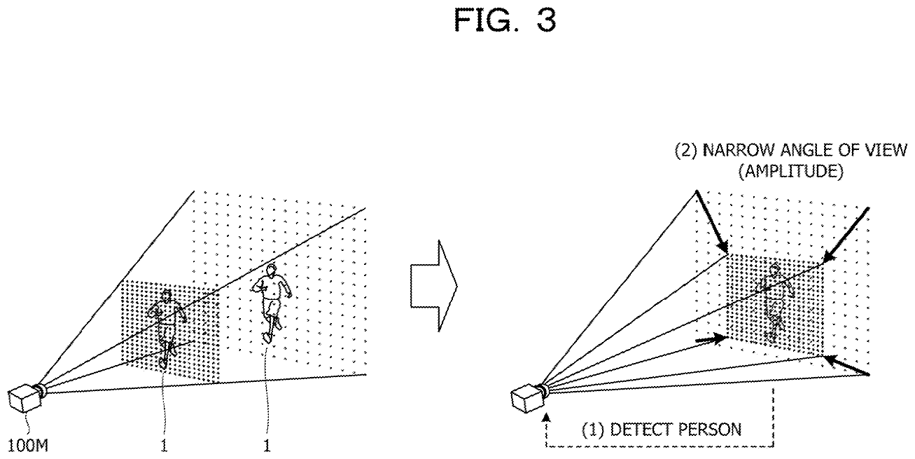

FIG. 3 is a diagram illustrating an example of a relationship between the master device 100M and the ranging target 1. For example, when the angle of view is set to be a fixed value as in the left side of FIG. 3 when an athlete who is the ranging target 1 runs toward the master device 100M, the number of pieces of three-dimensional point cloud data obtained through reflection on the ranging target 1 decreases when the ranging target 1 is far, and the number of pieces of three-dimensional point cloud data obtained through reflection on the ranging target 1 increases when the ranging target 1 is close. In this case, a resolution of the ranging target 1 differs depending on the distance between the master device 100M and the ranging target 1.

Therefore, as illustrated in the right of FIG. 3, if the angle of view is reduced (narrow) after the ranging target 1 is trained when the ranging target 1 is far, the three-dimensional point cloud data as many as that when the ranging target 1 is close in the left side of FIG. 3 is obtained, and it is possible to increase the resolution of the ranging target 1 even if the ranging target 1 is far.

In this way, the angle of view of the MEMS mirror 12 may be changed. To change the angle of view of the MEMS mirror 12 corresponds to changing the scanning amplitudes in the horizontal direction and the vertical direction of the MEMS mirror 12 illustrated in FIGS. 2(a) and 2(b). This is because the angle of view of a case where the MEMS mirror 12 performs scanning in the raster scan method is determined depending on the scanning amplitude of the MEMS mirror 12.

For example, if the scanning amplitude in the horizontal direction is changed to “2”, the angle of view of the MEMS mirror 12 in the horizontal direction is doubled, and if the scanning amplitude in the vertical direction is changed to “2”, the angle of view of the MEMS mirror 12 in the vertical direction is doubled. The control device 300 can set the scanning amplitudes in the horizontal direction and the vertical direction to any value. For example, the control device 300 performs angle-of-view setting control so as to set the angle of view to be wide when the ranging target is close and to set the angle of view to be narrow in a case where the ranging target is far.

Here, the angle of view is a scanning range of the MEMS mirror 12. The master device 100M is a device that scans the MEMS mirror 12 and acquires the three-dimensional point cloud data in order to measure the distance to the ranging target, and a three-dimensional shape (posture) of the ranging target can be obtained from the measured distance. The three-dimensional point cloud data represents a distribution of the distances from the master device 100M to the ranging target 1 and is not data representing an image. However, a range of a two-dimensional angle corresponding to an angle of view of a camera that acquires an image corresponds to the scanning range of the MEMS mirror 12. Therefore, here, there is a case where the scanning range of the MEMS mirror 12 is referred to as an angle of view.

By the way, when the master device 100M changes an angle of view, for example, by changing the scanning amplitude in the horizontal direction in FIG. 2(a) to “2” and “−2”, an amplitude of the sine wave increases, and there is a case where the zero timing when the scanning angle becomes zero shifts in a time axis direction at the time when the scanning amplitude is changed. The timing when the scanning angle becomes zero is a timing when a displacement of the sine wave becomes zero.

Since the slave device 100S controls light emission of laser light with reference to the zero timing supplied from the master device 100M, a problem may be caused in that an error occurs in the three-dimensional point cloud data acquired by the slave device 100S of which the angle of view is not changed similarly to the master device 100M, unless countermeasures against a deviation of the zero timing are taken on the side of the master device 100M in a case where the deviation occurs in the zero timing of the master device 100M. Since the master device 100M and the slave device 100S are typically arranged as interposing the ranging target 1 therebetween, the angles of view of the master device 100M and the slave device 100S are not similarly changed.

The master device 100M generates a zero timing by taking countermeasures so as not to cause an error in the three-dimensional point cloud data of the slave device 100S even if the zero timing is deviated in this way, and supplies the zero timing to the slave device 100S. Therefore, the master device 100M includes a timing output unit 140. Details of the timing output unit 140 will be described below.

<Configuration of Master Device 100M>

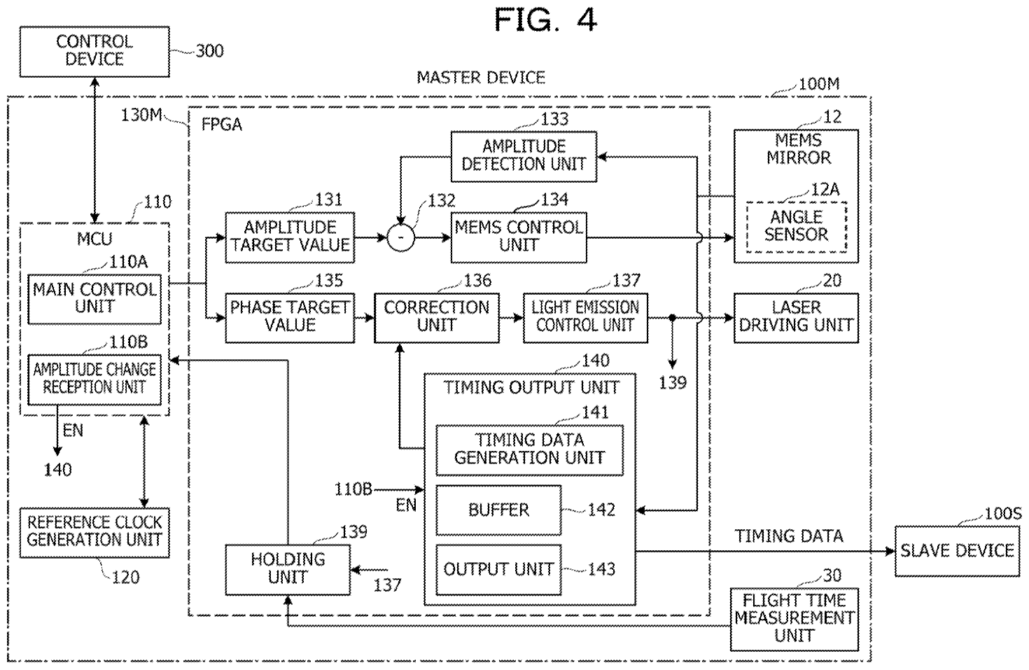

Here, a configuration of the master device 100M will be described with reference to FIGS. 1 and 4. FIG. 4 is a diagram for explaining internal configurations of the MCU 110 and the FPGA 130M of the master device 100M. In FIG. 4, in addition to the MCU 110 and the FPGA 130M of the master device 100M, the MEMS mirror 12, the laser driving unit 20, the flight time measurement unit 30, and the reference clock generation unit 120 of the master device 100M are illustrated, and the slave device 100S and the control device 300 are illustrated. In FIG. 4, the light emission device 11, the light receiving lens 13, and the light receiving element 14 are omitted. Here, the master device 100M, the slave device 100S, the control device 300, and the posture recognition system 400 will be described with reference to FIGS. 1 and 4.

The light emission device 11 is a device that emits laser light in accordance with an instruction of the laser driving unit 20 and includes a light emission element such as a semiconductor laser. As an example, the light emission device 11 emits pulse-like laser light at a predetermined sampling cycle. The FPGA 130M controls the laser driving unit 20. A timing when the laser driving unit 20 instructs the light emission device 11 to emit pulse-like laser light is sent from the laser driving unit 20 to the flight time measurement unit 30. For example, the flight time measurement unit 30 acquires a light emission timing of the pulse-like laser light.

The MEMS mirror 12 is a mirror that changes an angle of laser light that is three-dimensionally emitted. The MEMS mirror 12 is a two-axis rotation type mirror, in which the angle of emitted laser light three-dimensionally changes, for example, due to changes in a rotation angle of a horizontal axis and a rotation angle of a vertical axis. The rotation angle of the horizontal axis is referred to as a horizontal angle H, and the rotation angle of the vertical axis is referred to as a vertical angle V. The FPGA 130M instructs the horizontal angle H and the vertical angle V of the MEMS mirror 12. The pulse-like laser light emitted from the light emission device 11 is deflected according to the horizontal angle H and the vertical angle V of the MEMS mirror 12.

The pulse-like laser light reflected by the MEMS mirror 12 is emitted to a ranging target, scattered (reflected), and returns to the light receiving lens 13. This returning light is collected by the light receiving lens 13 and is received by the light receiving element 14.

The MEMS mirror 12 normally utilizes resonance for at least one axis of the two axes, namely, the horizontal axis and the vertical axis, in order to increase a scanning speed and also to increase a drive angle. In the present embodiment, as an example, normally, resonance is utilized in the horizontal direction in which the number of reciprocations is large.

Furthermore, the MEMS mirror 12 includes an angle sensor 12A. The angle sensor 12A outputs angle data representing an angle (drive angle) of the MEMS mirror 12 to the FPGA 130M. The angle represented by the angle data sinusoidally changes as the scanning angle illustrated in FIG. 2(a), with time.

The light receiving lens 13 transmits a reflected wave that the laser light (pulse-like laser light), which is reflected by the MEMS mirror 12, reflected by the ranging target, collects light, and guides the light to the light receiving element 14. The light receiving lens 13 collects light, and the light receiving element 14 receives light.

The light receiving element 14 is, for example, a photo diode (PD), and for example, an avalanche photo diode (APD) can be used. The light receiving element 14 outputs light-receiving timing data representing a light-receiving timing to the flight time measurement unit 30.

The laser driving unit 20 is a driving circuit that causes the light emission device 11 to emit light, based on a light emission control command input from the FPGA 130M. The laser driving unit 20 outputs light emission timing data representing a timing when the light emission device 11 is caused to emit light to the flight time measurement unit 30.

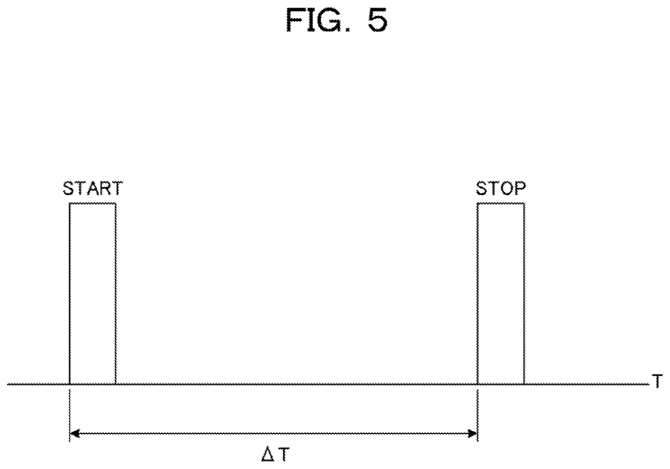

The flight time measurement unit 30 measures a distance to a ranging target by adopting the Time OF Flight (TOF) method. FIG. 5 is an explanatory diagram of the TOF method. The light emission timing data in FIG. 5 represents a timing (START) at which the light emission device 11 emits pulse-like laser light. The light-receiving timing data represents a timing (STOP) at which the laser light returned from the ranging target is received.

As illustrated in FIG. 5, the flight time measurement unit 30 measures a round-trip time (ΔT) from when the light emission device 11 emits pulse-like laser light and returning light returns from the ranging target, multiplies the measured round-trip time by a light speed so as to calculate a distance to the ranging target. Since the flight time measurement unit 30 can measure the distance each time when the light emission device 11 emits pulse-like laser light, the distance can be measured at the sampling cycle. The flight time measurement unit 30 outputs distance data representing a distance to a holding unit 139 of the FPGA 130M each time when the distance is calculated.

The control device 300 transmits a frequency of a reference clock signal that defines operation timings of the master device 100M and the slave device 100S to the master device 100M and the slave device 100S. The frequency transmitted from the control device 300 is received by the MCU 110.

The master device 100M sends a frame pulse (master frame pulse) and a line pulse (master line pulse) of the master device 100M to the inside of the master device 100M and the slave device 100S.

The MCU 110 is implemented by a computer that includes a central processing unit (CPU), a random access memory (RAM), a read only memory (ROM), a hard disk drive (HDD), an input/output interface, an internal bus, or the like. The MCU 110 includes a main control unit 110A and an amplitude change reception unit 110B. The main control unit 110A comprehensively controls an operation of the master device 100M. The main control unit 110A and the amplitude change reception unit 110B are illustrated as functional blocks of functions of a program executed by the MCU 110.

The main control unit 110A receives data representing the frequency of the reference clock signal from the control device 300. The reference clock signal is a clock signal that defines the operation timings of the master device 100M and the slave device 100S. The main control unit 110A outputs the data representing the frequency of the reference clock signal to the reference clock generation unit 120. The reference clock generation unit 120 generates a reference clock and outputs the reference clock to the main control unit 110A. The main control unit 110A outputs the reference clock, input from the reference clock generation unit 120, to the FPGA 130M. Furthermore, the main control unit 110A outputs a phase target value at which the light emission device 11 is caused to emit light or the like to the FPGA 130M.

When the amplitude change command is notified from the control device 300 when the control device 300 changes the scanning range of the laser light on the MEMS mirror 12, the amplitude change reception unit 110B outputs amplitude target data included in the amplitude change command to an amplitude target value holding unit 131 and outputs an amplitude change enable signal EN to the timing output unit 140. The amplitude change enable signal EN is a signal output by the control device 300 to the MCU 110 when the control device 300 changes the scanning amplitude (angle of view) of the MEMS mirror 12.

Upon acquiring the data representing the frequency of the reference clock signal from the main control unit 110A, the reference clock generation unit 120 generates the reference clock and outputs the reference clock to the main control unit 110A.

The FPGA 130M operates according to the reference clock input from the main control unit 110A and controls driving of the MEMS mirror 12 and controls light emission of the light emission device 11, based on amplitude target value of the MEMS mirror 12, the phase target value at which the light emission device 11 is caused to emit light, or the like.

The FPGA 130M includes the amplitude target value holding unit 131, a subtractor 132, an amplitude detection unit 133, a MEMS control unit 134, a phase target value holding unit 135, a correction unit 136, a light emission control unit 137, the holding unit 139, and the timing output unit 140. The timing output unit 140 includes a timing data generation unit 141, a buffer 142, and a data output unit 143. Here, in the master device 100M, the MEMS control unit 134 is an example of a first amplitude control unit, and the light emission control unit 137 is an example of a first light emission control unit.

The amplitude target value holding unit 131, the subtractor 132, the amplitude detection unit 133, the MEMS control unit 134, the phase target value holding unit 135, the correction unit 136, the light emission control unit 137, the holding unit 139, the timing output unit 140, the timing data generation unit 141, the buffer 142, and the data output unit 143 are illustrated as functional blocks of functions programmed in logic blocks of the FPGA 130M.

The amplitude target value holding unit 131 holds an amplitude target value indicated by the amplitude target data input from the main control unit 110A and outputs the amplitude target value to the subtractor 132. The amplitude target data indicates the amplitude target value of the MEMS mirror 12. The amplitude target value indicates a scanning amplitude. The scanning amplitude includes amplitudes in the two-axis (x-axis and y-axis) directions in FIG. 2(c).

The subtractor 132 outputs data representing a difference obtained by subtracting an amplitude of the MEMS mirror 12 input from the amplitude detection unit 133 from the amplitude target value input from the amplitude target value holding unit 131, to the MEMS control unit 134.

The amplitude detection unit 133 detects the amplitude of the MEMS mirror 12 based on an output of the angle sensor 12A of the MEMS mirror 12 and outputs the data representing the amplitude to the subtractor 132.

The MEMS control unit 134 controls driving of the MEMS mirror 12 so that the difference represented by the data output from the subtractor 132 becomes zero.

The phase target value holding unit 135 holds the phase target value input from the main control unit 110A and outputs the phase target value to the correction unit 136. The phase target value indicates a light emission timing with reference to the zero timing as a phase. For example, the phase target value indicates a light emission timing with reference to a start point of a frame.

The correction unit 136 corrects the phase target value input from the phase target value holding unit 135, based on timing data representing a timing when the scanning angle of the MEMS mirror 12 input from the timing output unit 140 becomes zero and outputs the corrected phase target value to the light emission control unit 137.

The light emission control unit 137 outputs the light emission timing data, at which the light emission device 11 is caused to emit light to the laser driving unit 20, so as to control light emission based on the corrected phase target value input from the correction unit 136. Furthermore, the light emission control unit 137 outputs the light emission timing data to the holding unit 139. The light emission timing data at which the light emission device 11 is caused to emit light is data is data for first to 64,000-th light emissions in one frame. The light emission control unit 137 controls light emission of laser light by the light emission device 11 based on the timing data generated by the timing data generation unit 141.

The holding unit 139 holds the distance data input from the flight time measurement unit 30 in association with the light emission timing data input from the light emission control unit 137. Since the flight time measurement unit 30 outputs the distance data indicating a distance to the holding unit 139 each time when calculating the distance, the holding unit 139 holds the distance data each time when the distance data is input from the flight time measurement unit 30 and collects distance data for one frame. Since each piece of the distance data is associated with the light emission timing data representing a light emission timing when light emission control is performed, it is possible to find at which light emission timing the distance data is obtained. Therefore, it is possible to obtain three-dimensional point cloud data.

The holding unit 139 holds the distance data for one frame, and when acquiring the distance data for one frame, outputs the distance data for one frame to the main control unit 110A. The main control unit 110A outputs the distance data for one frame to the control device 300.

The timing output unit 140 includes the timing data generation unit 141, the buffer 142, and the data output unit 143. To the timing output unit 140, the angle data is input from the angle sensor 12A of the MEMS mirror 12, and the amplitude change enable signal EN is input from the amplitude change reception unit 110B. The timing output unit 140 outputs the timing data indicating the zero timing to the correction unit 136 and the slave device 100S.

The timing data generation unit 141 detects a zero timing of the scanning angle of the MEMS mirror 12 based on the angle data input from the angle sensor 12A and generates timing data indicating the zero timing. The timing data generation unit 141 generates the timing data and outputs the timing data to the buffer 142, each time when the angle data is input. The timing data generation unit 141 constantly outputs the timing data indicating the zero timing to the buffer 142 while driving of the MEMS mirror 12 is controlled.

The buffer 142 includes a storage unit 142A and a holding unit 142B. The storage unit 142A is a ring buffer that stores the timing data generated by the timing data generation unit 141. The holding unit 142B holds timing data for the latest one frame. In a case where the zero timing of the master device 100M deviates, the timing data for the latest one frame is used instead of the deviated zero timing. Since the deviation of the zero timing of the master device 100M caused at the time when the angle of view is changed converges within one frame in most cases, the holding unit 142B has a capacity that can hold timing data for one frame.

When the amplitude change enable signal EN is not input from the amplitude change reception unit 110B to the timing output unit 140, the buffer 142 stores the timing data generated by the timing data generation unit 141 in the storage unit 142A and outputs the timing data to the correction unit 136 and the data output unit 143. The timing data is transmitted to the slave device 100S via the data output unit 143. The buffer 142 incorporates a processing unit that performs such processing.

The buffer 142 writes (store) the timing data into the storage unit 142A each time when the timing data is input from the timing data generation unit 141, and when the timing data for one frame is accumulated (collected) in the storage unit 142A, makes the holding unit 142B hold the timing data for one frame. The holding unit 142B holds the timing data for the latest one frame each time when one frame is completed.

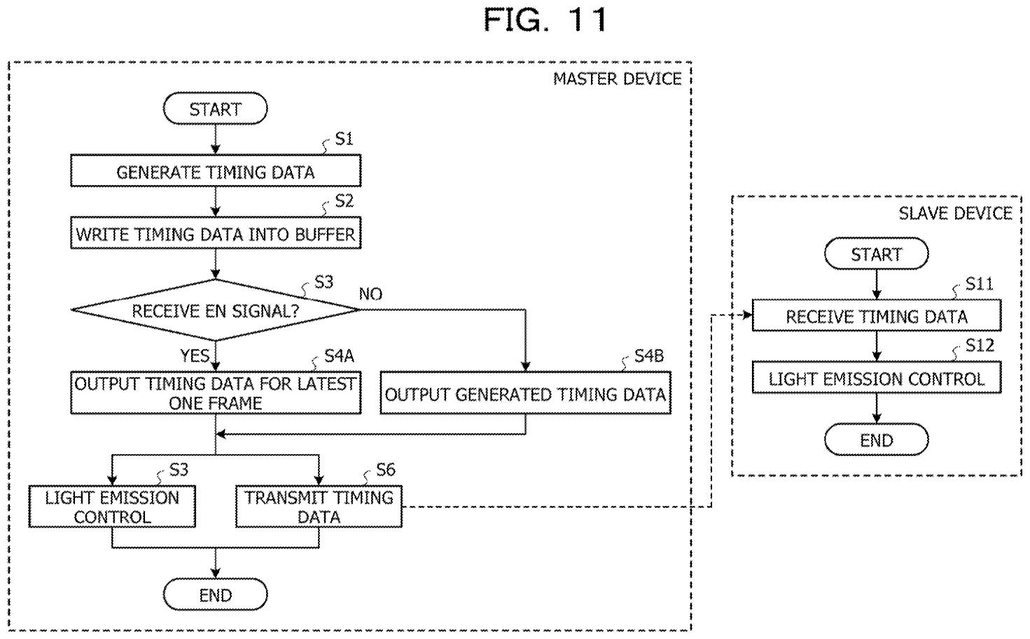

Furthermore, when the amplitude change enable signal EN is input from the amplitude change reception unit 110B to the timing output unit 140, the buffer 142 stores the timing data in the storage unit 142A and outputs the timing data for the latest one frame held by the holding unit 142B to the correction unit 136 and the data output unit 143. The timing data for the latest one frame is transmitted to the slave device 100S via the data output unit 143 at a timing indicated by each of a plurality of zero timings included in the timing data. Details of this will be described with reference to the flowchart in FIG. 11.

When the amplitude change enable signal EN is not input from the amplitude change reception unit 110B to the timing output unit 140 and the holding unit 142B outputs all the timing data for the latest one frame, the buffer 142 outputs the timing data generated by the timing data generation unit 141 to the correction unit 136 and the data output unit 143.

The data output unit 143 outputs the timing data to the slave device 100S, and in addition, outputs a frame pulse (master frame pulse) indicating a frame start timing, a line pulse (master line pulse) indicating a timing of a horizontal scanning star timing, a time stamp, or the like while synchronous multiplexing them.

<Configuration of Slave Device 100S>

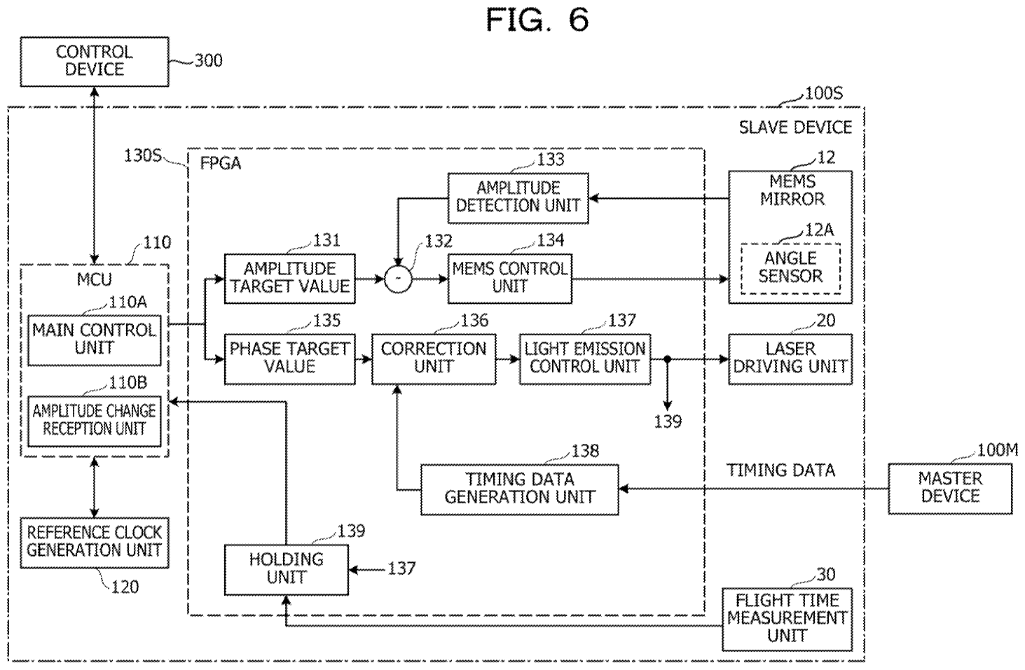

FIG. 6 is a diagram for explaining an internal configuration of the slave device 100S. FIG. 6 is a diagram corresponding to FIG. 4 for the master device 100M. Like the master device 100M, the slave device 100S includes the light emission device 11, the light receiving lens 13, and the light receiving element 14. However, the light emission device 11, the light receiving lens 13, and the light receiving element 14 are omitted here. Note that, in the slave device 100S, the light emission device 11 is an example of a second light emission unit, and the laser light emitted by the light emission device 11 is an example of second laser light. The MEMS mirror 12 is an example of a second MEMS mirror, and the light receiving element 14 is an example of a second light reception unit. The MCU 110 is an example of a second control device.

In addition to the light emission device 11, the light receiving lens 13, and the light receiving element 14 (refer to FIG. 4), the slave device 100S includes the MEMS mirror 12, the laser driving unit 20, the flight time measurement unit 30, the MCU 110, the reference clock generation unit 120, and a FPGA 130S. The slave device 100S does not include the timing output unit 140. A component similar to the component of the master device 100M is denoted with the same reference numeral, and description thereof will be omitted. Hereinafter, the slave device 100S will be described focusing on differences from the master device 100M.

The MCU 110 includes a main control unit 110A and an amplitude change reception unit 110B. When the amplitude change command is notified from the control device 300 when the control device 300 changes the scanning range of the laser light on the MEMS mirror 12, the amplitude change reception unit 110B outputs the amplitude target data included in the amplitude change command to the amplitude target value holding unit 131. However, the amplitude change reception unit 110B is different from the amplitude change reception unit 110B of the master device 100M in that the amplitude change reception unit 110B does not output the amplitude change enable signal EN.

The FPGA 130S operates according to the reference clock input from the main control unit 110A and controls driving of the MEMS mirror 12 and controls light emission of the light emission device 11, based on the amplitude target value of the MEMS mirror 12, the phase target value at which the light emission device 11 is caused to emit light, or the like, based on the timing data supplied from the master device 100M.

The FPGA 130S includes the amplitude target value holding unit 131, the subtractor 132, the amplitude detection unit 133, the MEMS control unit 134, the phase target value holding unit 135, the correction unit 136, the light emission control unit 137, and a timing data acquisition unit 138. The FPGA 130S is different from the FPGA 130M in that the FPGA 130S does not include the holding unit 139 and the timing output unit 140 as in the FPGA 130M and includes the timing data acquisition unit 138. Here, in the slave device 100S, the MEMS control unit 134 is an example of a second amplitude control unit, and the light emission control unit 137 is an example of a second light emission control unit.

The amplitude target value holding unit 131, the subtractor 132, the amplitude detection unit 133, the MEMS control unit 134, the phase target value holding unit 135, the correction unit 136, light emission control unit 137, and the timing data acquisition unit 138 are illustrated as functional blocks of functions programmed in logic blocks of the FPGA 130S.

The timing data acquisition unit 138 acquires timing data output from the data output unit 143 of the timing output unit 140 of the master device 100M. When the amplitude change enable signal EN is not input from the amplitude change reception unit 110B to the master device 100M, the timing data acquisition unit 138 acquires the timing data generated by the timing data generation unit 141, and when the amplitude change enable signal EN is input from the amplitude change reception unit 110B to the master device 100M, the timing data acquisition unit 138 acquires timing data for the latest one frame.

<Generation and Transmission to Slave Device 100S of Timing Data>

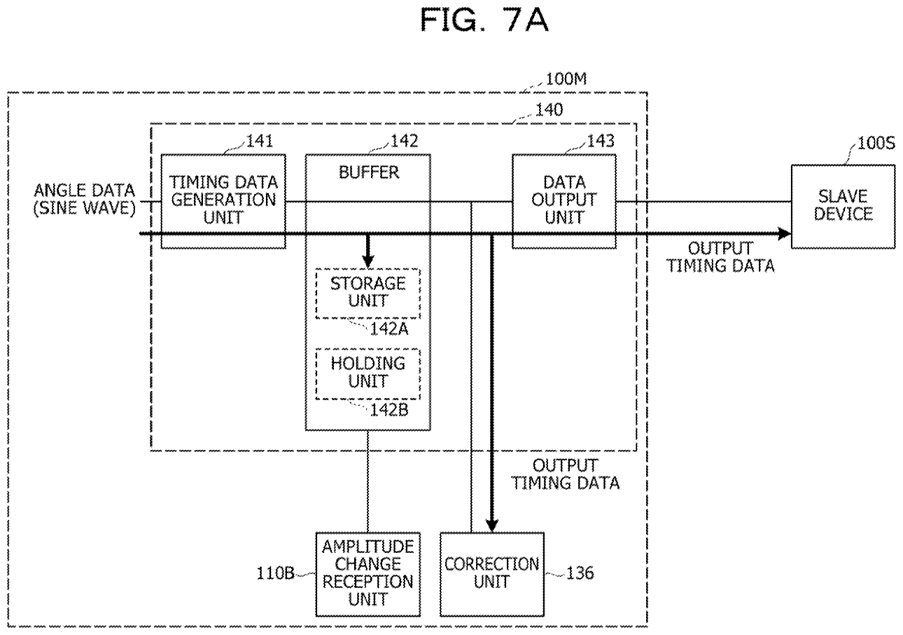

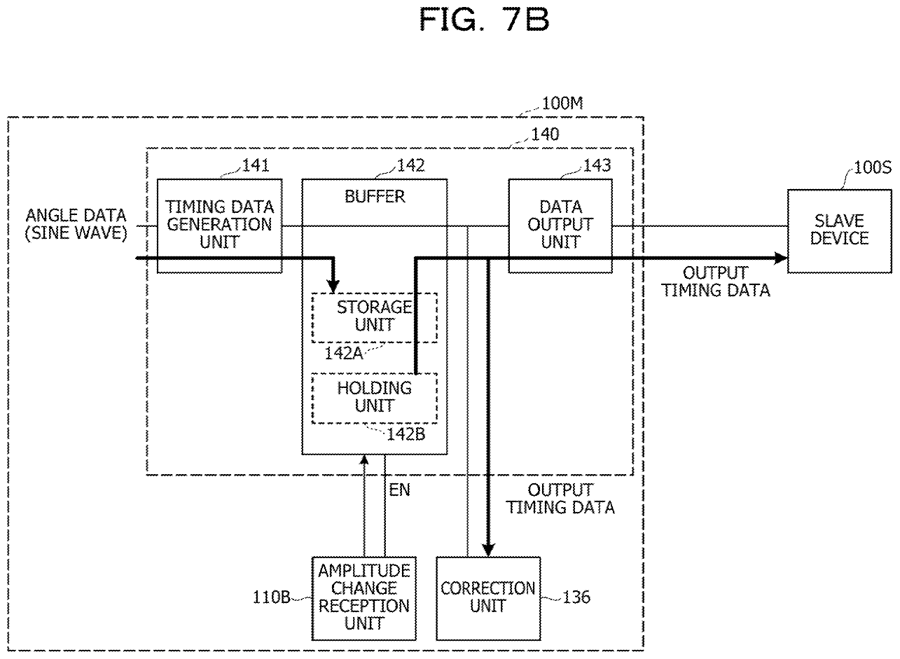

FIGS. 7A and 7B are diagrams for explaining generation, storage, and holding of the timing data in the timing output unit 140 and transmission of the timing data to the slave device 100S.

In FIG. 7A, the amplitude change reception unit 110B does not output the amplitude change enable signal EN. Therefore, the buffer 142 stores the timing data generated by the timing data generation unit 141 in the storage unit 142A, and outputs the timing data generated by the timing data generation unit 141 to the correction unit 136 and the data output unit 143. The timing data is transmitted to the slave device 100S via the data output unit 143.

As illustrated in FIG. 7A, when the storage unit 142A stores the timing data and the timing data for one frame is accumulated, the buffer 142 makes the holding unit 142B hold the timing data for one frame. Therefore, the holding unit 142B holds the timing data for the latest one frame each time when one frame is completed.

Furthermore, as illustrated in FIG. 7B, when the amplitude change enable signal EN is input from the amplitude change reception unit 110B to the timing output unit 140, the buffer 142 stores the timing data in the storage unit 142A and outputs the timing data for the latest one frame held by the holding unit 142B to the correction unit 136 and the data output unit 143. The timing data for the latest one frame is transmitted to the slave device 100S via the data output unit 143.

As a result, when the timing data generated by the timing data generation unit 141 is input to the correction unit 136 and the scanning amplitude of the laser light on the MEMS mirror 12 is not changed, the correction unit 136 corrects the phase target value based on the timing data generated by the timing data generation unit 141. Furthermore, when the scanning amplitude of the laser light on the MEMS mirror 12 is changed, the correction unit 136 corrects the phase target value based on the timing data for the latest one frame output from the buffer 142.

<Operations of Master Device 50M for Comparison and Slave Device 100S>

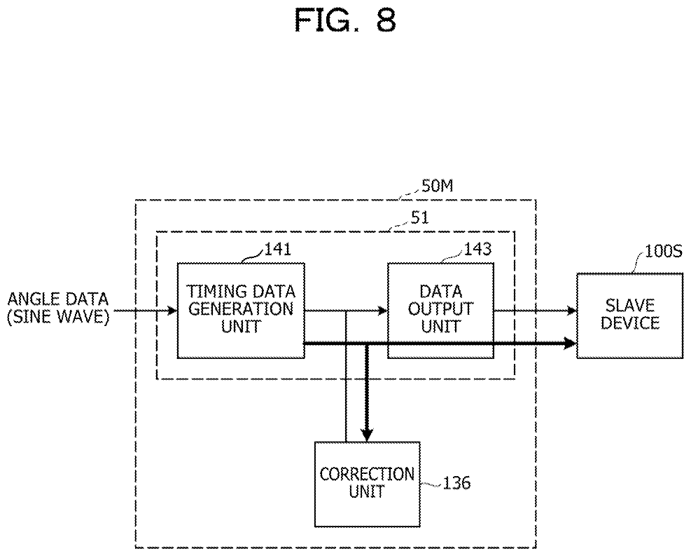

FIG. 8 is a diagram illustrating an example of a master device 50M for comparison. Here, a case where the master device 50M for comparison and the slave device 100S performs synchronization control will be described. The master device 50M for comparison includes a timing output unit 51 for comparison instead of the timing output unit 140 in the embodiment, and the amplitude change reception unit 110B is configured not to output the amplitude change enable signal EN.

The timing output unit 51 for comparison includes the timing data generation unit 141 and the data output unit 143, and timing data generated by the timing data generation unit 141 is constantly supplied to the correction unit 136 and the data output unit 143. Therefore, when the amplitude change command is input from the control device 300, a zero timing deviation occurs in the timing data generated by the timing data generation unit 141 of the master device 50M.

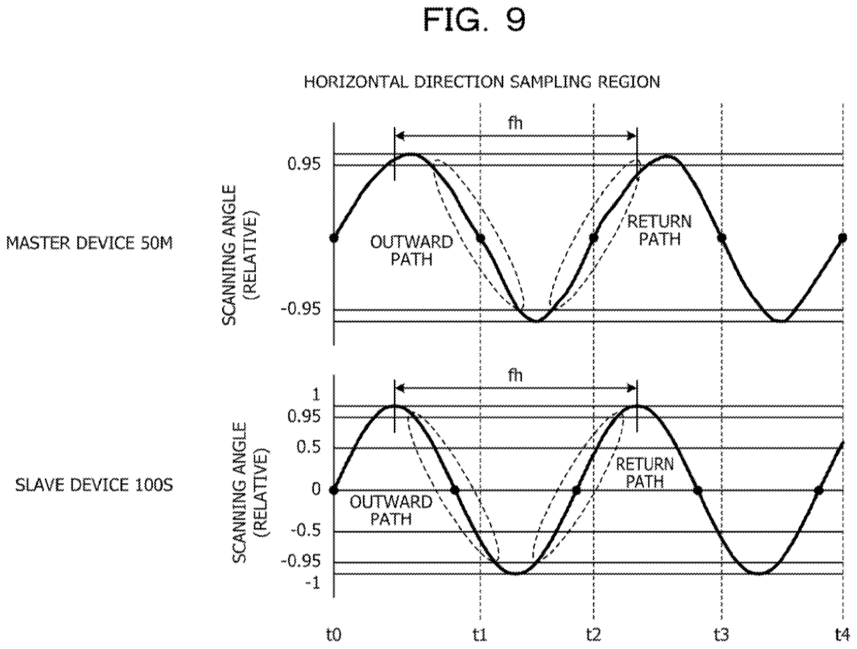

FIG. 9 is a diagram illustrating horizontal sampling regions of the master device 50M and the slave device 100S. In FIG. 9, the horizontal sampling region of the master device 50M is illustrated on the upper side, and the horizontal sampling region of the slave device 100S is illustrated on the lower side. Furthermore, a zero timing when the scanning angles of the master device 50M and the slave device 100S become zero is indicated by a black circle (●).

Here, description will be made as assuming that the angle of view of the MEMS mirror 12 of the master device 100M is changed in response to the amplitude change command immediately after a time t0 and before a time t1 and the angle of view of the MEMS mirror 12 of the slave device 100S is not changed.

As illustrated in FIG. 9, at the zero timing t0 when the scanning angle of the master device 50M is zero, the zero timings of the master device 50M and the slave device 100S match. However, at times t1 to t4 indicating the zero timing of the master device 50M, the scanning angle of the slave device 100S does not become zero, and the zero timings of the master device 50M and the slave device 100S do not match. This is because the zero timing of the master device 50M is changed.

In this way, in a case where the slave device 100S operates using the timing data supplied from the master device 50M for comparison, if the angle of view is changed and the zero timing of the master device 50M deviates, an error occurs in the three-dimensional point cloud data acquired by the slave device 100S of which the angle of view is not changed similarly to the master device 100M.

<Operations of Master Device 100M and Slave Device 100S>

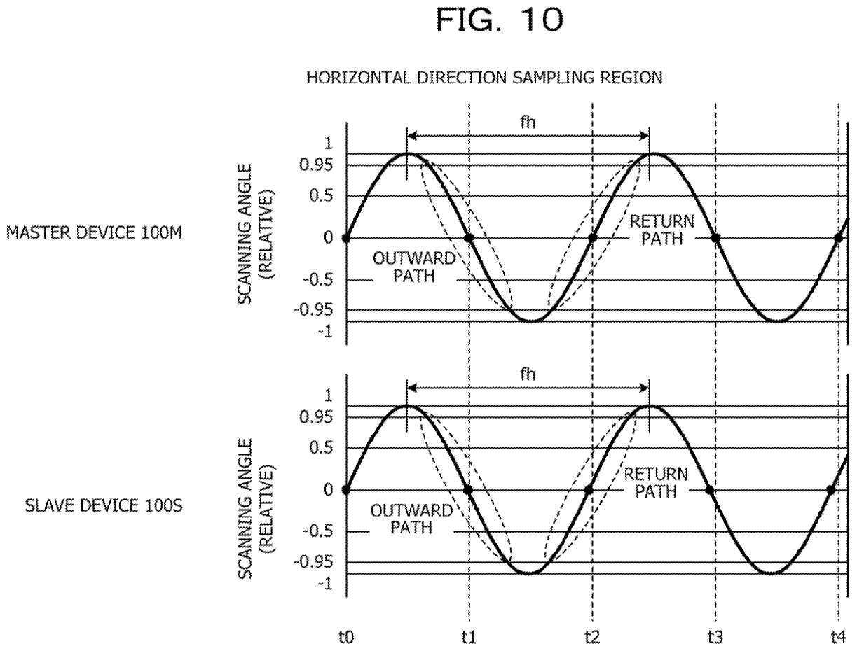

FIG. 10 is a diagram illustrating horizontal sampling regions of the master device 100M and the slave device 100S. In FIG. 10, the horizontal sampling region of the master device 100M is illustrated on the upper side, and the horizontal sampling region of the slave device 100S is illustrated on the lower side. Furthermore, a zero timing when the scanning angles of the master device 100M and the slave device 100S become zero is indicated by a black circle (●).

Here, as in FIG. 9, description will be made as assuming that the angle of view is changed in response to the amplitude change command immediately after the time t0 and before the time t1. As illustrated in FIG. 10, at the zero timing t0 when the scanning angle of the master device 100M is zero, the zero timings of the master device 100M and the slave device 100S match. Furthermore, at any one of times t1 to t4 after the time t1 when the angle of view is changed, the zero timings of the master device 100M and the slave device 100S match.

When the angle of view is changed, the master device 100M outputs timing data for the latest one frame obtained in an immediately-previous frame to the light emission control unit 137 and the data output unit 143. Therefore, even when the angle of view of the master device 100M is changed, a state can be maintained in which the zero timings of the master device 100M and the slave device 100S match.

<Flowchart>

FIG. 11 is a flowchart illustrating an example of processing related to light emission control in the master device 100M and the slave device 100S. In FIG. 11, in a tasks format, processing of the light emission control unit 137 and the timing output unit 140 of the master device 100M is illustrated on the left side, and processing of the light emission control unit 137 and the timing data acquisition unit 138 of the slave device 100S is illustrated on the right side.

<Processing of Master Device 100M>

When processing starts, the timing data generation unit 141 generates timing data based on the angle data input from the angle sensor 12A (step S1).

The buffer 142 stores the timing data in the storage unit 142A (step S2).

The buffer 142 determines whether or not the amplitude change enable signal EN is input from the amplitude change reception unit 110B to the timing output unit 140 (step S3).

When determining that the amplitude change enable signal EN is input (S3: YES), the buffer 142 outputs timing data indicating a zero timing corresponding to a current light emission timing, from timing data for the latest one frame held by the holding unit 142B to the correction unit 136 and the data output unit 143 (step S4A). When the processing in step S4A ends, the flow proceeds to steps S5 and S6.

On the other hand, when determining that the amplitude change enable signal EN is not input (S3: NO), the buffer 142 outputs the timing data generated by the timing data generation unit 141 to the correction unit 136 and the data output unit 143 (step S4B). When the processing in step S4A ends, the flow proceeds to steps S5 and S6.

When the processing in steps S4A and S4B ends, the FPGA 130M executes processing in steps S5 and S6. The processing in step S5 and the processing in step S6 are simultaneously executed in parallel.

The light emission control unit 137 outputs the light emission timing data, at which the light emission device 11 is caused to emit light, to the laser driving unit 20, based on the corrected phase target value input from the correction unit 136 (step S5). For example, light emission control is performed by the light emission control unit 137 of the master device 100M.

Furthermore, the data output unit 143 transmits (transfer) the timing data to the slave device 100S (step S6).

The master device 100M repeats the processing in steps S1 to S5 and S6 at each light emission timing so that the timing data indicating the zero timing to be a reference of light emission timing is output to the light emission control unit 137 and the data output unit 143.

<Processing of Slave Device 100S>

When starting processing, the timing data acquisition unit 138 receives (acquire) the timing data from the data output unit 143 of the master device 100M (step S11).

The light emission control unit 137 outputs the light emission timing data, at which the light emission device 11 is caused to emit light, to the laser driving unit 20, based on the corrected phase target value input from the correction unit 136 (step S12). For example, light emission control is performed by the light emission control unit 137 of the slave device 100S.

The slave device 100S repeats the processing in steps S11 and S12 at each light emission timing so that the timing data indicating the zero timing to be the reference of the light emission timing is input via the data output unit 143, and it is possible to perform light emission control.

As described above, the series of processing ends (end). The master device 100M and the slave device 100S repeatedly execute the processing illustrated in FIG. 11.

<Description of Angle-of-View Control>

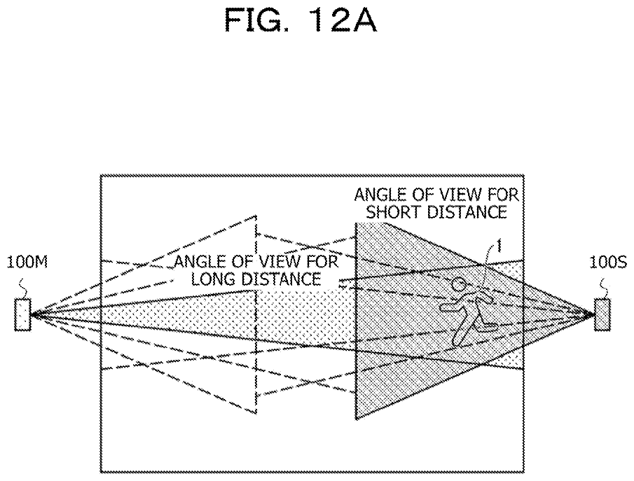

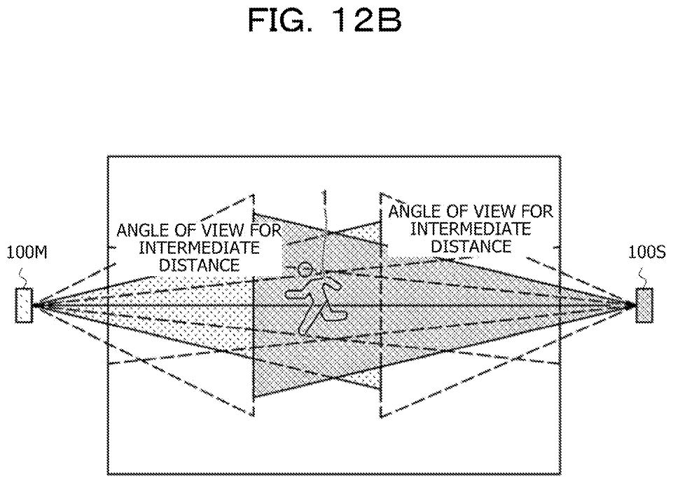

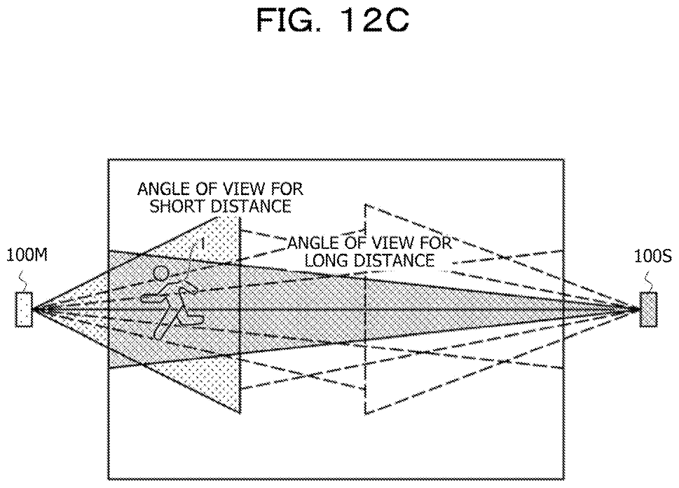

FIGS. 12A, 12B, and 12C are diagrams for explaining angle-of-view control. In FIG. 12A, the ranging target 1 is far from the master device 100M and is close to the slave device 100S. Therefore, the control device 300 (refer to FIG. 1) transmits an amplitude change command used for setting an angle of view for a long distance to the master device 100M and transmits an amplitude change command for setting an angle of view for a short distance to the slave device 100S.

In FIG. 12B, the ranging target 1 is positioned at the middle of the master device 100M and the slave device 100S. Therefore, the control device 300 (refer to FIG. 1) transmits an amplitude change command for setting an angle of view for an intermediate distance to the master device 100M and the slave device 100S.

In FIG. 12C, the ranging target 1 is close to the master device 100M and is far from the slave device 100S. Therefore, the control device 300 (refer to FIG. 1) transmits an amplitude change command for setting an angle of view for a short distance to the master device 100M and transmits an amplitude change command for setting an angle of view for a long distance to the slave device 100S.

As described above, it is sufficient to set an angle of view according to the distances between the ranging target 1 and the master device 100M and the slave device 100S. When the angle of view is changed, as described above, it is sufficient that the master device 100M output the timing data for the latest one frame held by the holding unit 142B.

<Comparison of Angle-of-View Control by Master Device 100M and Master Device 50M for Comparison>

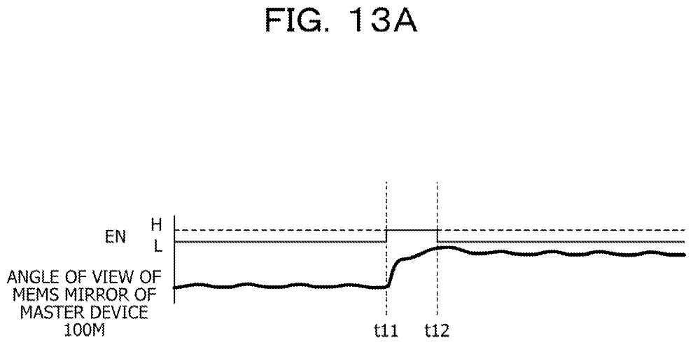

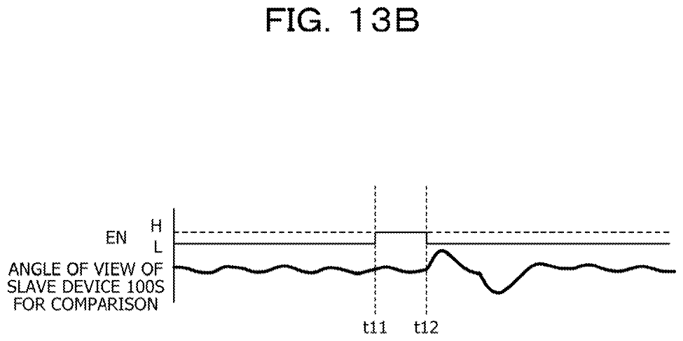

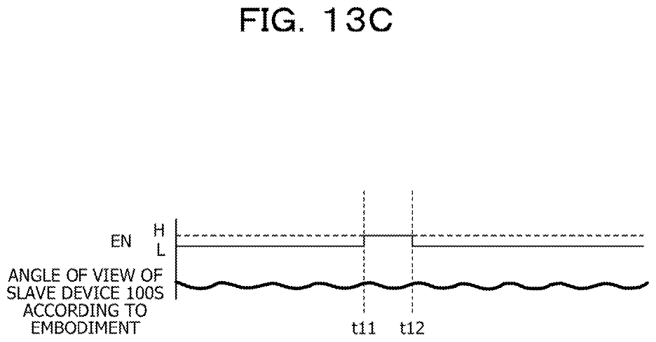

FIG. 13A is a diagram illustrating a state of temporal changes in the amplitude change enable signal EN input to the master device 100M and the angle of view of the MEMS mirror 12 of the master device 100M. In FIGS. 13A to 13C, the horizontal axis indicates time, and the vertical axis indicates an amplitude (L, H) of the amplitude change enable signal EN and the angle of view of the MEMS mirror 12 of the master device 100M. A Low (L) level of the amplitude change enable signal EN is synonymous with that the amplitude change enable signal EN is not input to the master device 100M, and a High (H) level of the amplitude change enable signal EN is synonymous with that the amplitude change enable signal EN is input to the master device 100M.

When the amplitude change enable signal EN reaches the H level at a time t11, the angle of view of the MEMS mirror 12 of the master device 100M fluctuates, and when the amplitude change enable signal EN returns to the L level at a time t12, the angle of view is substantially constant thereafter.

FIG. 13B is a diagram illustrating a state of temporal changes in the amplitude change enable signal EN input to the master device 50M for comparison and the angle of view of the MEMS mirror 12 of the slave device 100S that operates with the timing data acquired from the master device 50M for comparison. Note that it is assumed that the amplitude change command be not input to the slave device 100S.

When the amplitude change enable signal EN reaches the H level at the time t11, the angle of view of the MEMS mirror 12 of the slave device 100S fluctuates, and the angle of view fluctuates after the amplitude change enable signal EN returns to the L level at the time t12. This is an effect caused by the deviation of the zero timing of the master device 50M for comparison. Since the amplitude change command is not input to the slave device 100S, the angle of view of the MEMS mirror 12 of the slave device 100S should be constant essentially. However, the fluctuation occurs in this way.

FIG. 13C is a diagram illustrating a state of temporal changes in the amplitude change enable signal EN input to the master device 100M and the angle of view of the MEMS mirror 12 of the slave device 100S that operates with the timing data acquired from the master device 100M. Note that it is assumed that the amplitude change command be not input to the slave device 100S.

Although the amplitude change enable signal EN reaches the H level at the time t11 and the amplitude change enable signal EN returns to the L level at the time t12, the angle of view of the MEMS mirror 12 of the slave device 100S is substantially constant.

As illustrated in FIG. 13C, when the amplitude change enable signal EN reaches the H level, the master device 100M according to the first embodiment outputs the timing data for the latest one frame held by the holding unit 142B of the buffer 142 to the light emission control unit 137 and the data output unit 143. Therefore, it is possible to prevent the fluctuation of the angle of view of the MEMS mirror 12 of the slave device 100S and to stabilize the operation of the slave device 100S.

<Application Example of Posture Recognition System 400>

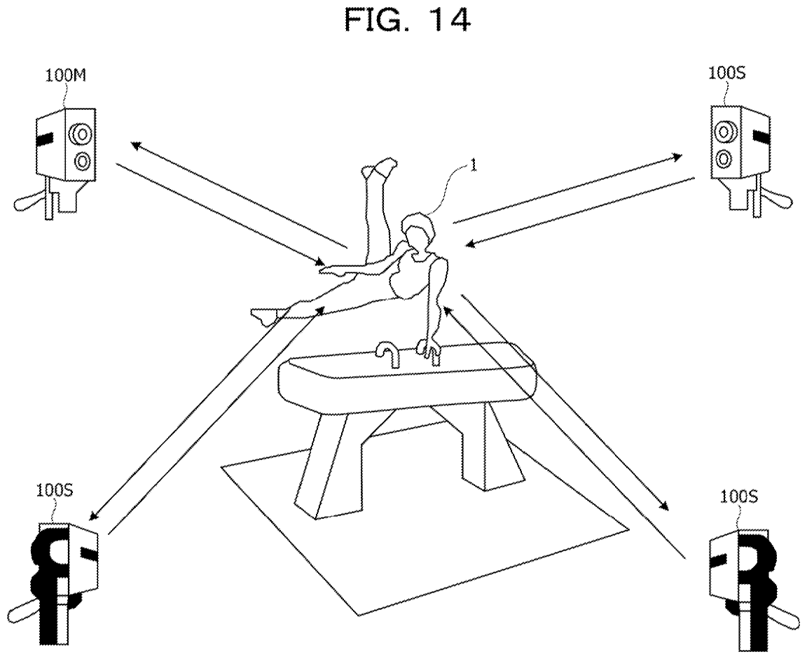

FIG. 14 is a diagram illustrating an application example of the posture recognition system 400. As illustrated in FIG. 14, one master device 100M and three slave devices 100S are provided. These master device 100M and slave devices 100S are provided so as to surround the ranging target 1 (gymnast athlete in example in FIG. 14). There is a possibility that some parts of the athlete's own body or equipment causes shadows, which produce a portion of the athlete's body for which three-dimensional point cloud data may not be acquired. Therefore, the master device 100M and the slave devices 100S are provided so as to sandwich the athlete from the front and back sides. This makes it possible to measure detailed three-dimensional point data (posture data) of the athlete. By outputting the timing data for the latest one frame from the master device 100M to the own device (master device 100M) and the slave device 100S when the angle of view is changed, it is possible to prevent the deviation of the zero timing of the master device 100M. Therefore, in both states when the angle of view is not changed and the angle of view is changed, in a state where the master device 100M and the slave device 100S are synchronously controlled, it is possible to accurately measure the detailed three-dimensional point data (posture data) of the athlete.

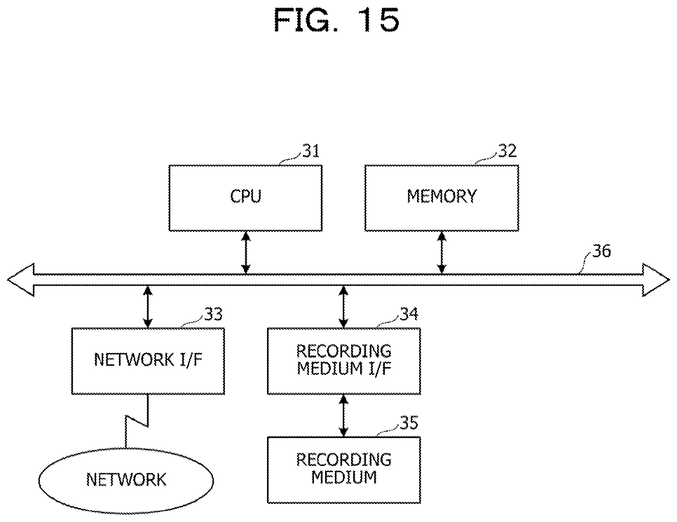

FIG. 15 is a hardware configuration example of the master device 100M. In FIG. 15, the master device 100M includes a CPU 31, a memory 32, a network interface (I/F) 33, a recording medium I/F 34, and a recording medium 35. Furthermore, the components are connected to each other with a bus 36.

Here, the CPU 31 performs overall control of the master device 100M. The memory 32 includes, for example, a ROM, a RAM, a flash ROM, or the like. For example, the flash ROM or the ROM stores various programs, and the RAM is used as a work area for the CPU 31. The programs stored in the memory 32 are loaded into the CPU 31 to cause the CPU 31 to execute coded processing.

The network I/F 33 is connected to a network through a communication line, and is connected to another computer through the network. Then, the network I/F 33 manages an interface between the network and the inside, and controls input and output of data to and from another computer. The network I/F 33 is, for example, a modem, a LAN adapter, or the like.

The recording medium I/F 34 controls reading and writing of data from and to the recording medium 35 under the control of the CPU 31. The recording medium I/F 34 is, for example, a disk drive, an SSD, a USB port, or the like. The recording medium 35 is a nonvolatile memory that stores the data written under the control of the recording medium I/F 34. The recording medium 35 is, for example, a disk, a semiconductor memory, a USB memory, or the like. The recording medium 35 may be attachable to and detachable from the master device 100M.

Note that, a function of each component included in the MCU 110 and the FPGA 130M of the master device 100M may be implemented by causing the CPU 31 to execute a program stored in a storage region such as the memory 32 or the recording medium 35 or by the network I/F 33. A computer system is not limited to a computer system with the configuration illustrated in FIGS. 1 and 2, and various well-known components may be added or may be used as alternatives.

<Effects>

As described above, the master device 100M includes the light emission device 11 that emits laser light and the MEMS control unit 134 that controls the scanning amplitude of the MEMS mirror 12 that scans the laser light emitted by the light emission device 11 in a raster scan method. Furthermore, the master device 100M includes the timing data generation unit 141 that generates the timing data indicating the timing when the scanning angle of the MEMS mirror 12 becomes zero based on the operation of the MEMS mirror 12 and the buffer 142 that stores the timing data in one frame of the scanning of the MEMS mirror 12. Furthermore, the master device 100M includes the light emission control unit 137 that performs light emission control of the laser light by the light emission device 11, based on the timing data generated by the timing data generation unit 141 and the data output unit 143 that outputs data to the slave device 100S that operates as being dependent on the own device. When the scanning amplitude of the laser light on the MEMS mirror 12 is changed, the light emission control unit 137 controls light emission using the timing data for one frame held by the buffer 142 instead of the timing data generated by the timing data generation unit 141, and the data output unit 143 outputs the timing data for one frame stored in the buffer 142 to the slave device 100S. Therefore, when the angle of view of the MEMS mirror 12 is changed, it is possible to prevent the deviation of the zero timing of the master device 100M, and the slave device 100S can stably operate.

Therefore, it is possible to provide the master device 100M and the sensor system 200 that can supply the timing data that stably operates the slave device 100S to the slave device 100S.

Furthermore, since the buffer 142 holds the timing data for the latest one frame generated by the timing data generation unit 141, when the angle of view of the MEMS mirror 12 is changed, the buffer 142 can supply the timing data for one frame when the angle of view of the MEMS mirror 12 is not changed to the own device (master device 100M) and the slave device 100S. Although the zero timing of the master device 100M is deviated when the angle of view of the MEMS mirror 12 is changed, the zero timing indicated by the timing data for one frame when the angle of view of the MEMS mirror 12 is not changed is not deviated. Therefore, it is possible to prevent the deviation of the zero timing of the master device 100M at the time when the angle of view is changed. Therefore, by supplying the timing data for the latest one frame generated by the timing data generation unit 141 to the own device (master device 100M) and the slave device 100S, it is possible to more stably operate the slave device 100S.

Furthermore, the buffer 142 includes the storage unit 142A that stores the timing data for one frame and the holding unit 142B that holds the collected timing data for one frame and the timing data for the latest one frame over the next one frame period when the timing data for one frame is collected in the storage unit 142A. Since the storage unit 142A is a ring buffer, the storage unit 142A can store generated timing data each time when the timing data generation unit 141 generates the timing data. Furthermore, when the timing data for one frame is collected, the holding unit 142B can reliably hold the timing data for one frame. The timing data for one frame held by the holding unit 142B is timing data for the latest one frame that is completed before the current frame in which the change of the angle of view is controlled. Therefore, by holding the timing data for the latest one frame by the holding unit 142B, the timing data for the latest one frame can be reliably and easily supplied to the slave device 100S. As a result, it is possible to more stably operate the slave device 100S.

Furthermore, when the scanning amplitude of the laser light on the MEMS mirror 12 is changed, the buffer 142 outputs the timing data for the latest one frame held by the holding unit 142B to the light emission control unit 137 and the slave device 100S. Then, the light emission control unit 137 controls light emission based on the timing data for the latest one frame output from the buffer 142, instead of the timing data generated by the timing data generation unit 141. Therefore, the timing data for the latest one frame can be reliably used for light emission control in the master device 100M and light emission control in the slave device 100S. Since the master device 100M and the slave device 100S use the common timing data (timing data for latest one frame) even when the angle of view is changed, it is possible to more stably operate the slave device 100S.

The master device 100M further includes the correction unit 136 that corrects the phase target value that indicates the light emission timing used to control the light emission by the light emission control unit 137 based on the timing data. Then, when the scanning amplitude of the laser light on the MEMS mirror 12 is not changed, the correction unit 136 corrects the phase target value based on the timing data generated by the timing data generation unit 141. Furthermore, when the scanning amplitude of the laser light on the MEMS mirror 12 is changed, the correction unit 136 corrects the phase target value based on the timing data for the latest one frame output from the buffer 142. Therefore, it is possible to correct the phase target value based on the timing data for the latest one frame output from the buffer 142 when the angle of view of the MEMS mirror 12 is changed and to control light emission based on the corrected phase target value.

Furthermore, the master device 100M further includes the light receiving element 14 that receives first reflection light of the laser light emitted by the light emission device 11. Then, the light emission control unit 137 controls light emission, based on the timing data, so as to alternately ensure a first period needed to emit the laser light by the light emission device 11 and receive reflection light by the light receiving element 14 and a second period needed to emit the second laser light by the slave device 100S and receive second reflection light by the slave device 100S. Therefore, the master device 100M and the slave device 100S can alternately acquire the three-dimensional point cloud data, and it is possible to prevent an interference of the laser light from each other and to acquire the accurate three-dimensional point cloud data. As a result, the master device 100M and the slave device 100S can prevent the interference of the laser light from each other and accurately measure the distance to the ranging target 1. Therefore, it is possible to provide the master device 100M and the sensor system 200 that can reliably prevent the interference of the laser light with the slave device 100S and can accurately measure the distance to the ranging target 1.

Note that, in the above, a mode has been described in which the buffer 142 outputs the timing data for the latest one frame held by the holding unit 142B to the light emission control unit 137 and the data output unit 143 in the current frame (next frame of frame in which timing data for latest one frame is collected). This is because most of deviations of the zero timing of the master device 100M caused at the time when the angle of view is changed converge within one frame. However, in a case where the angle of view is changed over a plurality of frames, the following may be performed.

In a case where the angle of view is changed over the plurality of frames, the MCU 110 outputs the amplitude change enable signal EN to the timing output unit 140 over the plurality of frames. In this case, while the amplitude change enable signal EN is input, it is sufficient that the buffer 142 cause the holding unit 142B hold the timing data for the latest one frame at the time of input start of the amplitude change enable signal EN until the amplitude change enable signal EN is no longer input, and output the timing data for one frame held by the buffer 142 to the light emission control unit 137 and the data output unit 143 in a period of the plurality of frames when the amplitude change enable signal EN is input.

For example, in a case where the scanning amplitude of the laser light on the MEMS mirror 12 is changed over the plurality of frames, it is sufficient that the buffer 142 cause the holding unit 142B to hold the timing data for the latest one frame immediately before the change of the scanning amplitude over the plurality of frames and output the timing data for one frame held by the holding unit 142B to the light emission control unit 137 and the data output unit 143 over the plurality of frames.

Since the timing data for one frame held by the holding unit 142B immediately before the change of the angle of view is started is very likely to be acquired without changing the angle of view, it may be considered that the timing data does not include the deviation of the zero timing. Therefore, in a case where the angle of view is changed over the plurality of frames, it is possible to output the timing data for one frame that does not include the deviation of the zero timing over the plurality of frames to the light emission control unit 137 and the data output unit 143 and to stably operate the slave device 100S.

Furthermore, in the above, a mode has been described in which the master device 100M includes the MCU 110 and the FPGA 130M and the FPGA 130M includes the amplitude target value holding unit 131, the subtractor 132, the amplitude detection unit 133, the MEMS control unit 134, the phase target value holding unit 135, the correction unit 136, the light emission control unit 137, the holding unit 139, and the timing output unit 140 as functional blocks. However, the functional blocks of the FPGA 130M may be implemented by the MCU 110. Furthermore, at least a part of the main control unit 110A and the amplitude change reception unit 110B that are the functional blocks of the MCU 110 may be included in the functional blocks of the FPGA 130M. Furthermore, an application specific integrated circuit (ASIC) may be used instead of the FPGA 130M. Note that the same applies to the slave device 100S.

The master device and the sensor system according to the exemplary embodiment of the present disclosure have been described above. However, the present disclosure is not limited to the specifically disclosed embodiment, and various changes and alterations can be made without departing from the scope of the claims.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A master device comprising:
a light emission circuit configured to emit first laser light;
an amplitude control circuit configured to control a scanning amplitude of a micro electro mechanical system (MEMS) mirror that scans the first laser light emitted by the light emission circuit in a raster scan method;
a timing data generation circuit configured to generate timing data that indicates a timing when a scanning angle of the MEMS mirror becomes zero, based on an operation of the MEMS mirror;
a buffer configured to store the timing data in one frame of the scanning of the MEMS mirror;
a light emission control circuit configured to control light emission of the first laser light by the light emission circuit, based on the timing data generated by the timing data generation circuit; and
a data output circuit configured to output data to a slave device that operates dependent on an own device, wherein
when the scanning amplitude of the first laser light on the MEMS mirror is changed, the light emission control circuit controls the light emission by using the timing data for one frame held by the buffer instead of the timing data generated by the timing data generation circuit, and the data output circuit outputs the timing data for one frame stored in the buffer to the slave device.

2. The master device according to claim 1, wherein the buffer holds the timing data for a latest one frame generated by the timing data generation circuit.

3. The master device according to claim 2, wherein
the buffer includes
a storage circuit that stores the timing data for one frame, and
a holding circuit that, when the timing data for one frame is collected in the storage circuit, holds the collected timing data for one frame and the timing data for the latest one frame over a next one frame period.

4. The master device according to claim 3, wherein
when the scanning amplitude of the first laser light on the MEMS mirror is changed, the buffer outputs the timing data for the latest one frame held by the holding circuit to the light emission control circuit and the slave device, and
the light emission control circuit controls the light emission based on the timing data for the latest one frame output from the buffer instead of the timing data generated by the timing data generation circuit.

5. The master device according to claim 4, wherein in a case where the scanning amplitude of the first laser light on the MEMS mirror is changed over a plurality of frames, the buffer causes the holding circuit to hold the timing data for the latest one frame immediately before the change of the scanning amplitude over the plurality of frames, and outputs the timing data for the latest one frame to the light emission control circuit and the slave device over the plurality of frames.

6. The master device according to claim 4, further comprising:
a correction circuit configured to correct a phase target value that indicates a timing of light emission used to control the light emission by the light emission control circuit based on the timing data, wherein
the correction circuit,
when the scanning amplitude of the first laser light on the MEMS mirror is not changed, corrects the phase target value based on the timing data generated by the timing data generation circuit, and
when the scanning amplitude of the first laser light on the MEMS mirror is changed, corrects the phase target value based on the timing data for the latest one frame output from the buffer.

7. The master device according to claim 1, further comprising:
a light reception circuit configured to receive first reflection light of the first laser light emitted by the light emission circuit, wherein
the light emission control circuit controls the light emission, based on the timing data, so as to alternately ensure a first period needed to emit the first laser light by the light emission circuit and receive the reflection light by the light reception circuit and a second period needed to emit second laser light and receive second reflection light by the slave device.

8. A sensor system comprising: a master device; and a slave device that operates dependent on the master device, wherein
the master device includes
a first light emission circuit that emits first laser light,
a first amplitude control circuit that controls a scanning amplitude of a first MEMS mirror that scans the first laser light emitted by the first light emission circuit in a raster scan method,
a timing data generation circuit that generates timing data that indicates a timing when a scanning angle of the first MEMS mirror becomes zero, based on an operation of the first MEMS mirror,
a buffer that stores the timing data in one frame of the scanning of the first MEMS mirror,
a first light emission control circuit that controls light emission of the first laser light by the first light emission circuit, based on the timing data generated by the timing data generation circuit, and
a data output circuit that outputs data to the slave device, and
the slave device includes
a second light emission circuit that emits second laser light,
a second amplitude control circuit that controls a scanning amplitude of a second MEMS mirror that scans the second laser light emitted by the second light emission circuit in a raster scan method, and
a second light emission control circuit that controls light emission of the second laser light by the second light emission circuit, based on the timing data supplied from the master device, and
when the scanning amplitude of the first laser light on the first MEMS mirror is changed, the first light emission control circuit controls the light emission by using the timing data for one frame stored in the buffer instead of the timing data generated by the timing data generation circuit, and the data output circuit outputs the timing data for one frame stored in the buffer to the slave device.
